(19) United States
(12) Patent Application Publication
(10) Pub. No.: US 2014/0266868 A1
(43) Pub. Date: Sep. 18, 2014

(54) Methods And Systems For Multiple Input Multiple Output Synthetic Aperture Radar Ground Moving Target Indicator

(71) Applicant: SRC, Inc., North Syracuse, NY (US)

(72) Inventor: Harvey K. Schuman, Fayetteville, NY (US)

(73) Assignee: SRC, INC., North Syracuse, NY (US)

(21) Appl. No.: 14/215,246

(22) Filed: Mar. 17, 2014

Related U.S. Application Data
(60) Provisional application No. 61/793,799, filed on Mar. 15, 2013.

(51) Int. Cl. G01S 13/90; G01S 7/02; G01S 13/00

(52) U.S. Cl. CPC G01S 13/9029; G01S 13/003; G01S 7/02
USPC 342/25 B; 342/25 R

(57) ABSTRACT

A multiple-input multiple-output (MIMO) synthetic aperture radar (SAR) system. The radar system includes spatially offset transmitting antennas simultaneously transmitting at least two distinguishable waveform signals and receiving antennas receiving incoming waveform returns for each of the distinguishable waveform signals. The radar system also includes a displaced phase center antenna (DPCA) processing unit adapted to perform processing on the incoming waveform returns, and a synthetic aperture radar processing unit adapted to produce a plurality of spatially-coincident SAR-processed signals. The radar system also generates a plurality of clutter-suppressed signals using the spatially-coincident SAR-processed signals. For each of two MIMO transmissions from spatially displaced transmitters, clutter is cancelled simultaneously in at least two spatially displaced receive channels via DPCA processing. This results in at least two spatially displaced but simultaneous clutter cancelled complex SAR images, which are combined in a monopulse processor to enhance target detection and unambiguously determine target angle.

### CROSS-REFERENCE TO RELATED APPLICATIONS

This application claims priority to U.S. Provisional Patent Application Ser. No. 61/793,799, filed on Mar. 15, 2013, and entitled “Methods and Systems for Multiple Input Multiple Output Synthetic Aperture Radar Ground Moving Target Indicator,” the entire disclosure of which is incorporated herein by reference.

### BACKGROUND

The present invention relates to methods and systems for signal processing, and, more particularly, to radar methods and systems that enable cancellation of clutter on receive while preserving angle estimation.

Multiple-input multiple-output (“MIMO”) uses multiple transmitting and receiving antennas to improve the capabilities of a variety of systems including communications and radar. With multiple transmitting antennas, a MIMO system is capable of simultaneously sending more than one data stream or signal. Similarly, the receiver antennas of a MIMO system can receive multiple data streams or signals. The ability to receive and distinguish multiple signals allows a MIMO system to surmount problems associated with multipath effects in which transmitted information is scattered by obstacles and reaches the receiving antennas at different times with different angles.

MIMO systems often utilize multiple transmit waveforms in which the waveforms of the many multiplexed signals transmitted simultaneously by the transmit antennas are varied to make them separable. In other words, each transmit antenna transmits a waveform that is separable from the signals transmitted by the other transmit antennas. Thus, while each receive antenna will simultaneously receive all the transmitted waveforms, each individual waveform must be separable from the other signals. Individual waveforms can be made separable through phase/amplitude coding, amplitude (time), frequency, or other methods.

Multichannel Synthetic Aperture Radar (“SAR”) can be used to detect ground moving targets from an overhead moving-platform. This function, referred to as Ground Moving Target Indicator (“GMTI”), is usually performed by either Displaced Phase Center Antenna (“DPCA”) or by Along Track Interferometry (“ATI”), or by a combination of DPCA and ATI. Both methods have limitations, as ATI is not as effective in suppressing clutter as is DPCA, and while ATI can provide the angles to detected targets, DPCA cannot. Accordingly, there is a continued need for methods and systems that effectively suppress clutter and provide the angles to detected targets.

### BRIEF SUMMARY

In accordance with the foregoing objects and advantages, methods and systems for GMTI which enable cancellation of clutter on receive by virtue of a Displaced Phase Center Antenna Multichannel Synthetic Aperture Radar architecture, while preserving angle estimation virtue of a Multiple Input Multiple Output architecture. Clutter is suppressed by subtracting specially formed complex SAR images. For example, consider the “two-way phase center” corresponding to one pair of transmit and receive antenna channels and the two-way phase center of another pair; if the data of one pair can be adjusted to effectively cause the phase centers to overlap, but the data capture displaced in time, signals from stationary ground scatterers will cancel upon subtraction. The system can be generalized to higher order DPCA nulling by introducing additional such two-way path channels, all of phase centers made coincident in space but progressively displaced in time. The MIMO transmit waveforms can be made distinguishable by one of several methods including Code Division Multiple Access, Frequency Division Multiple Access or Time Division Multiple Access.

According to an aspect, a multiple-input multiple-output (MIMO) radar system for monitoring motion of a movable target is provided. The radar system includes: (i) at least two spatially offset transmitting antennas, wherein at least two distinguishable waveform signals are simultaneously transmitted; (ii) a plurality of receiving antennas adapted to receive incoming waveform returns for each of the at least two distinguishable waveform signals; (iii) a displaced phase center antenna processing unit operatively connected to the receiving antennas and adapted to process the incoming waveform returns for each of the at least two distinguishable waveform signals; (iv) a synthetic aperture radar (SAR) processing unit operatively connected to the receiving antennas and adapted to produce from the incoming radar signals a plurality of spatially-coincident SAR-processed signals; and (v) a processing circuit operatively connected to the SAR processing unit and the DPCA processing unit and adapted to generate a plurality of clutter-suppressed signals using the spatially-coincident SAR-processed signals.

According to an embodiment, the radar system comprises a predetermined pulse repetition interval, platform velocity, and channel spacing such that SAR processing unit is able to produce spatially-coincident SAR-processed signals.

According to an embodiment, the radar system comprises a plurality of matched transmit and receive channel pairs, the channel pairs being spatially separated parallel to an along-track axis.

According to an embodiment, two clutter suppressed images are computed simultaneously by the processing circuit.

According to an embodiment, the processing unit is further configured to determine the angle of a target.

According to an embodiment, the radar system further comprises a sum-difference monopulse processor.

According to an embodiment, the radar system further comprises an angle estimator adapted to utilize sum and difference patterns to determine an angle of detection.

According to an aspect is a radar comprising: (i) at least two spatially offset transmitting antennas, wherein at least two distinguishable waveform signals are simultaneously transmitted; (ii) a plurality of receiving antennas adapted to receive incoming waveform returns for each of the at least two distinguishable waveform signals; and (iii) a processor operatively connected to the spatially offset transmitting antennas and the plurality of receiving antennas, the processor comprising: a displaced phase center antenna module adapted to process the incoming waveform returns for each of the at least two distinguishable waveform signals; a synthetic aperture radar (SAR) module adapted to produce from the incoming radar signals a plurality of spatially-coincident SAR-processed signals; wherein the processor is adapted to generate a plurality of clutter-suppressed signals using the spatially-coincident SAR-processed signals.

According to an embodiment, the radar comprises a predetermined pulse repetition interval, platform velocity, and channel spacing such that SAR processing unit is able to produce spatially-coincident SAR-processed signals.

According to an embodiment, the radar comprises a plurality of matched transmit and receive channel pairs, the channel pairs being spatially separated parallel to an along-track axis.

According to an embodiment, two clutter suppressed images are computed simultaneously by the processing circuit.

According to an embodiment, the processing unit is further configured to determine the angle of a target.

According to an embodiment, the processor further comprises a sum-difference monopulse module.

According to an embodiment, the processor further comprises an angle estimator module adapted to utilize sum and difference patterns to determine an angle of detection.

Per another aspect is provided a non-transitory computer-readable storage medium storing computer-executable instructions for performing the steps of: (i) receiving, from a plurality of receiving radar antennas, incoming waveform returns for each of the at least two distinguishable waveform signals; (ii) processing, using a displaced phase center antenna algorithm, the incoming waveform returns for each of the at least two distinguishable waveform signals; (iii) producing, from the incoming radar signals, a plurality of spatially-coincident SAR-processed signals; and (iv) generating a plurality of clutter-suppressed signals using the spatially-coincident SAR-processed signals.

According to an embodiment, the non-transitory computer-readable storage medium further comprises instructions for performing the step of determining the angle of a target.

According to an embodiment, the non-transitory computer-readable storage medium further comprises instructions for performing the step of determining an angle of detection utilizing sum and difference patterns.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a diagrammatic representation of a Displaced Phase Center Antenna Multichannel Synthetic Aperture Radar architecture in accordance with an embodiment;

FIG. 2 is a diagrammatic representation of a MIMO Ground Moving Target Indicator SAR architecture in accordance with an embodiment;

FIG. 3 is a diagrammatic representation of a MIMO Ground Moving Target Indicator SAR architecture in accordance with an embodiment;

FIG. 4 is a diagrammatic representation of a MIMO Ground Moving Target Indicator SAR architecture in accordance with an embodiment;

FIG. 5 is a diagrammatic representation of a two-antenna Time Division Multiple Access architecture in accordance with an embodiment; and

FIG. 6 is a diagrammatic representation of a radar architecture in accordance with an embodiment.

### DETAILED DESCRIPTION

According to one embodiment is a method or system for GMTI which enables cancellation of clutter on receive by virtue of a Displaced Phase Center Antenna Multichannel Synthetic Aperture Radar architecture, while preserving angle estimation by virtue of a Multiple In Multiple Out architecture. Clutter is suppressed by subtracting specially formed complex SAR images. For example, consider the “two-way phase center” corresponding to one pair of transmit and receive antenna channels and the two-way phase center of another pair; if the data of one pair can be adjusted to effectively cause the phase centers to overlap, but the data capture displaced in time, signals from stationary ground scatterers will cancel upon subtraction. The system can be generalized to higher order DPCA nulling by introducing additional such two-way path channels, all of phase centers made coincident in space but progressively displaced in time. The MIMO transmit waveforms can be made distinguishable by one of several methods including Code Division Multiple Access, Frequency Division Multiple Access or Time Division Multiple Access.

DPCA SAR is a GMTI function wherein clutter is suppressed by subtracting specially formed complex SAR images. According to an embodiment, the “two-way phase center” is considered corresponding to one pair of transmit and receive antenna channels and the two-way phase center of another pair, where the two-way phase center is that spatial point of reference of which the delay (or advance) of the transmitted signal is cancelled by the advance (or delay) of the received signal. If the data of one pair can be adjusted to effectively cause the phase centers to overlap but the data capture displaced in time, signals from stationary ground scatterers (clutter) will cancel upon subtraction. This operation is “first order DPCA nulling.” The system can be generalized to higher order DPCA nulling by introducing additional such two-way path channels, all of (two-way) phase centers made coincident in space but progressively displaced in time. The DPCA output is formed by linearly combining the channel signals with the binomial expansion coefficients; that is, the coefficients in the expansion of (a-b)^{(N-1)} where N denotes the number of two-way path channels.

According to an embodiment, one means of making the N SAR images “spatially coincident” is by the judicious selection of conveniently deployed antenna phase centers and ensuring that the pulse repetition interval (T), the platform velocity (vₚ), and channel spacing satisfy the “DPCA condition.” Alternatively, if the transmit and receive channel pairs applied for all SAR images are matched and spatially separated parallel to the along-track axis, the SAR images can be transformed to satisfy the spatially coincident, temporally displaced condition. The transformation can be computed from navigational readings of vₚ or from correlation of Doppler transformed channel data.

Upon combining the resulting time-displaced-spatially-coincident images in accordance with DPCA processing as described above, the amplitudes of resolution cells related to moving targets should emerge from the clutter, enhancing target detectability. In these “clutter suppressed images,” the Doppler of the resolution cell that a target appears to reside in will be the sum of the Doppler imparted by the platform motion and that imparted by the target motion. Because angle and Doppler are unambiguously related only for stationary scatterers, the target angles apparent in the SAR image generally will not be the actual target angles.

However, if two or more spatially offset transmitters are employed that transmit distinguishable waveform signals simultaneously, two clutter suppressed images can be computed simultaneously and the differences in phase between signals in corresponding resolution cells would relate directly to the angle of the target appearing in that resolution cell. If d denotes the spatial offset of the transmitters, θ, the complement of the cone angle (for a cone of axis coincident with the platform velocity vector), and λ the wavelength, the angular resolution of a target is given by Δ sin(θ)=λ/(2Kd) for a “K+1-element array.” If the signals are combined in a sum-difference monopulse processor enabling P:1 beamsplitting, the resolution is given by Δ sin(θ)=λ/(2PKd).

Further, the monopulse sum signal can be applied to the clutter suppressed images thus increasing target signal to noise ratio (SNR) and improving target detection. Combining the K+1 elements offsets the reduction in SNR associated with spreading the power among the K+1 distinguishable-waveform signals.

The sine angle is ambiguous with ambiguity interval of λ/d. Consider the conditions for unambiguous angle measurement. For example, assume all movers are limited to a Doppler velocity between +/−vₘ. The SAR image resolution cell Doppler velocity associated with a detected target is offset from the ground Doppler velocity at the location of the target by the target Doppler velocity. This offset is directly related to an angular offset. If θ′ denotes the apparent angle and v the target Doppler velocity, the offset is given by sin θ′−sin θ=v/vₚ. Thus, target offsets are confined to

|Δ sin(θ)|<vₘ/vₚ (1)

And, with ambiguity interval λ/d, the angle of the target is then unambiguous if

d/λ21 vₚ/2vₘ (2)

Note that the temporal shift needed for overlapping the phase centers corresponding to the two DPCA images is given by T=dₚ/vₚ where dₚ denotes the phase center separation. Application of ATI yields the phase shift resulting from target motion given by

Φ=(2Π/λ)(2v dₚ/vₚ) (3)

where v denotes the target Doppler velocity. The ambiguity in Φ implies that v is unambiguous if

−λvₚ/(4dₚ)<v<λvₚ/(4dₚ) (4)

For maximum positive target Doppler velocity, vₘ, then, the condition for unambiguous v is

vₘ<λvₚ/(4dₚ) (5)

dₚ/λ<vₚ/4vₘ (6)

or half that of the MIMO case.

If, however, DPCA is applied instead of ATI in combining the two DPCA images (resulting in a second order DPCA process), the ambiguity condition matches that of MIMO. To see this, note that

1−exp(jΦ)=A exp(jψ) (7)

where A denotes an amplitude function. Therefore,

ψ=Φ/2+Π/2 (8)

ψ=(2Π/λ)(v dₚ/vₚ)₊Π/2 (9)

and the condition for unambiguous v is that given above for the MIMO case.

The MIMO transmit waveforms can be made distinguishable by one of several methods. These include Code Division Multiple Access (CDMA), Frequency Division Multiple Access (FDMA), and Time Division Multiple Access (TDMA). CDMA is the most involved to implement but efficiently utilizes bandwidth. FDMA is relatively simple to implement but requires that the pulse repetition frequency (PRF) be high enough to distinguish signals by Doppler spectrum if slow time FDMA, or extra bandwidth be available if fast time FDMA. TDMA is a generalization of DPCA SAR methods that alternate pulses between transmitters.

In the case of TDMA, the transmit signals are displaced in time by the PRI (T), which contradicts the simultaneity requirement of the MIMO method. By forming clutter suppressed images from spatially coincident, temporally displaced images that are formed from different transmitters, the simultaneity condition will be preserved. This procedure probably is limited to two clutter suppressed images.

For Linear Frequency Modulation (LFM) systems, frequency slope is another method of distinguishing waveforms; positive slope for one waveform (upchirp) and negative slope for the other (downchirp). This system also is limited to processing two clutter suppressed images.

One immediate advantage of the MIMO method of estimating angle is that only two antenna channels are adequate for the MIMO method, whereas current methods require a minimum of three such channels.

Referring now to the drawings, wherein like reference numerals refer to like parts throughout, there is seen in FIG. 1 an architecture for a twochannel system. Here, “correlators” refers to the waveform matched filter; e.g., correlators if CDMA, Doppler filters if “slow-time” FDMA, or matched filters if “fast-time” FDMA. TDMA is addressed separately herein. R(a,b) refers to the SAR image for receive antenna channel a and transmitter b, and R′(a,b) refers to the transformed SAR image such that the two-way phase center of R′(a,b) is coincident with that of R(a,b), but displaced in time. D(a) refers to the suppressed-clutter image of channel a. The D images are time coincident but of phase centers displaced by the distance between two-way phase centers d. The D images are linearly combined to form monopulse sum and difference patterns. A detector processes the sum patterns into a detection map. The angle estimator uses the sum and difference patterns to determine the angles of detections.

FIGS. 2-4 show other MIMO GMTI SAR architectures. FIGS. 2 and 3 pertain to 3-antenna and N-antenna architectures respectively, for first-order DPCA. FIG. 4 pertains to a 3-antenna architecture for second-order DPCA. These architectures are readily extendable to increased numbers of antennas and higher orders of DPCA. FIG. 5 shows a 2-antenna TDMA architecture. The separation between antenna phase centers is denoted s. The platform movement between pulse transmissions is denoted w, and given by Tvₚ. T1 denotes the location of the fore antenna at transmission of the leading pulse, and T2 denotes the location of aft antenna at transmission of the subsequent pulse. Pulse transmission toggles between the two antennas at the pulse repetition frequency. The circles indicate the antenna locations at transmission of T1 pulse and the crosses the locations at transmission of T2 pulse. The four two-way phase centers corresponding to transmission from one antenna and reception by another are shown denoted by the corresponding SAR images R(a,b). Note that R(1,1) and R(2,1) occur simultaneously and similarly R(1,2) and R(2,2). R(1,2) is transformed to form R′(1,1), and R(2,2) is transformed to form R′(2,1). The clutter suppressed images D1=R(1,1)-R′(1,1) and D2=R(2,1)-R′(2,1) are “simultaneous” clutter suppression maps with phase centers separated by s/2.

The DPCA baseline determined by the delay corresponding to the separation between R(1,2) and R(1,1) (and similarly between R(2,2) and R(2,1)) is only s/2−w. A second configuration results in larger baselines. However, the correlations between the reference and shifted SAR images then are not quite as good. The second configuration is shown in FIG. 6. Now, T1 denotes the location of the aft antenna at transmission of the leading pulse, and T2 denotes the location of the fore antenna at transmission of the subsequent pulse. Following the same procedure as before, note that R(1,1) is now delayed by the time corresponding to phase center separation s/2+w between R(1,1) and R(1,2) and similarly for R(2,2) and R(2,1). As before, the clutter suppressed images D1=R(1,1)-R′(1,1) and D2=R(2,1)-R′(2,1) are “simultaneous” clutter suppression maps with phase centers separated by s/2.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

A “module” or “component” as may be used herein, can include, among other things, the identification of specific functionality represented by specific computer software code of a software program. A software program may contain code representing one or more modules, and the code representing a particular module can be represented by consecutive or non-consecutive lines of code.

As will be appreciated by one skilled in the art, aspects of the present invention may be embodied/implemented as a computer system, method or computer program product. The computer program product can have a computer processor or neural network, for example, that carries out the instructions of a computer program. Accordingly, aspects of the present invention may take the form of an entirely hardware embodiment, an entirely software embodiment, and entirely firmware embodiment, or an embodiment combining software/firmware and hardware aspects that may all generally be referred to herein as a “circuit,” “module,” “system,” or an “engine.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

The program code may perform entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowcharts/block diagrams in the Figures illustrate the architecture, functionality, and operation of possible implementations of systems, methods, and computer program products according to various embodiments of the present invention. In this regard, each block in the flowcharts/block diagrams may represent a module, segment, or portion of code, which comprises instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A multiple-input multiple-output (MIMO) radar system for monitoring motion of a movable target, comprising;
at least two spatially offset transmitting antennas, wherein at least two distinguishable waveform signals are simultaneously transmitted;
a plurality of receiving antennas adapted to receive incoming waveform returns for each of said at least two distinguishable waveform signals;
a displaced phase center antenna processing unit operatively connected to said receiving antennas and adapted to process said incoming waveform returns for each of said at least two distinguishable waveform signals;
a synthetic aperture radar (SAR) processing unit operatively connected to said receiving antennas and adapted to produce from said incoming radar signals a plurality of spatially-coincident SAR-processed signals;
a processing circuit operatively connected to the SAR processing unit and the DPCA processing unit and adapted to generate a plurality of clutter-suppressed signals using the spatially-coincident SAR-processed signals.

2. The MIMO radar system of claim 1, wherein the radar system comprises a predetermined pulse repetition interval, platform velocity, and channel spacing such that SAR processing unit is able to produce spatially-coincident SAR-processed signals.

3. The MIMO radar system of claim 1, wherein the radar system comprises a plurality of matched transmit and receive channel pairs, the channel pairs being spatially separated parallel to an along-track axis.

4. The MIMO radar system of claim 1, wherein two clutter suppressed images are computed simultaneously by said processing circuit.

5. The MIMO radar system of claim 4, wherein said processing unit is further configured to determine the angle of a target.

6. The MIMO radar system of claim 1, further comprising a sum-difference monopulse processor.

7. The MIMO radar system of claim 1, further comprising an angle estimator adapted to utilize sum and difference patterns to determine an angle of detection.

8. A radar comprising;
at least two spatially offset transmitting antennas, wherein at least two distinguishable waveform signals are simultaneously transmitted;
a plurality of receiving antennas adapted to receive incoming waveform returns for each of said at least two distinguishable waveform signals;
a processor operatively connected to said spatially offset transmitting antennas and said plurality of receiving antennas, the processor comprising:
a displaced phase center antenna module adapted to process said incoming waveform returns for each of said at least two distinguishable waveform signals;
a synthetic aperture radar (SAR) module adapted to produce from said incoming radar signals a plurality of spatially-coincident SAR-processed signals;
wherein the processor is adapted to generate a plurality of clutter-suppressed signals using the spatially-coincident SAR-processed signals.

9. The radar of claim 8, wherein the radar comprises a predetermined pulse repetition interval, platform velocity, and channel spacing such that SAR processing unit is able to produce spatially-coincident SAR-processed signals.

10. The radar of claim 8, wherein the radar comprises a plurality of matched transmit and receive channel pairs, the channel pairs being spatially separated parallel to an along-track axis.

11. The radar of claim 8, wherein two clutter suppressed images are computed simultaneously by said processing circuit.

12. The radar of claim 8, wherein said processing unit is further configured to determine the angle of a target.

13. The radar of claim 8, wherein the processor further comprises a sum-difference monopulse module.

14. The radar of claim 8, wherein the processor further comprises an angle estimator module adapted to utilize sum and difference patterns to determine an angle of detection.

15. A non-transitory computer-readable storage medium storing computer-executable instructions for performing the following steps:
receiving, from a plurality of receiving radar antennas, incoming waveform returns for each of said at least two distinguishable waveform signals;
processing, using a displaced phase center antenna algorithm, the incoming waveform returns for each of said at least two distinguishable waveform signals;
producing, from the incoming radar signals, a plurality of spatially-coincident SAR-processed signals; and
generating a plurality of clutter-suppressed signals using the spatially-coincident SAR-processed signals.

16. The non-transitory computer-readable storage medium of claim 15, further comprising instructions for performing the step of determining the angle of a target.

17. The non-transitory computer-readable storage medium of claim 15, further comprising instructions for performing the step of determining an angle of detection utilizing sum and difference patterns.
